(19) United States
(12) Patent Application Publication
(10) Pub. No.: US 2025/0128540 A1
(43) Pub. Date: Apr. 24, 2025

(54) DEEP DISH AERODYNAMIC WHEEL AND ACCESSORIES

(71) Applicant: 2592497 ONTARIO INC., TORONTO (CA)

(72) Inventors: NICOLE VAN BEURDEN, TORONTO (CA); PHILIP WHITE, TORONTO (CA)

(21) Appl. No.: 18/690,441

(22) PCT Filed: Sep. 9, 2022
(86) PCT No.: PCT/CA2022/051355

§ 371 Date: Mar. 8, 2024

Related U.S. Application Data
(60) Provisional application No. 63/242,741, filed on Sep. 10, 2021.

(51) Int. Cl. B60B 1/00; B60B 7/00

(52) U.S. Cl. CPC B60B 1/003; B60B 7/0006

(57) ABSTRACT

Accessories for improving aerodynamic characteristics of wheels with an outer rim configured to operatively couple with a tire; an inner rim configured to be located radially inward of the outer rim at a radial distance away from a wheel hub; an adaptable circumferential membrane, configured to operatively couple to both the inner rim and the outer rim, being structurally configured to adapt to an external force and change shape when subject to the external forces; and an attachment assembly configured to operatively couple the adaptable circumferential membrane to the outer rim and the inner rim as an overlay to wheel structural elements coupling the hub to the tire. The adaptable circumferential membrane with at least one air engaging flexible and aerodynamic surface configured to deform under the external force and to return to a neutral position when the external force is no longer present.

### CROSS-REFERENCE TO RELATED APPLICATIONS

The present application claims priority from U.S. Provisional Patent Application No. 63/242,741 filed on Sep. 10, 2021, the contents being incorporated herein by reference.

### FIELD

The specification relates generally to a wheel for a vehicle, and specifically to a wheel having improved aerodynamics.

### BACKGROUND

Using a bicycle as an example of a vehicle, a significant force acting against the movement of the bicycle is the drag induced by the bicycle's movement through the air. These drag forces are particularly problematic for athletic and professional cyclists. The power required to overcome this drag force is generally proportional to the speed of the vehicle raised to the third power. Greater speed results in greater drag which in turn requires the cyclist to expend greater energy to overcome the drag and this detrimentally affects a cyclist's performance. Accordingly, reducing the drag forces is an important consideration for racing cyclists and for other serious cyclists.

A major source of drag on a bicycle results from the flow of air over and around the bicycle wheels. It is known that conventional wheels for bicycles typically comprise a rim carrying a tire which rolls on the ground, a hub rotatable on a pin fixed to the bicycle frame, and a plurality of spokes connecting the rim to the hub. Traditional spoked wheels are generally stable in crosswinds and, depending on the materials used in their manufacture, can be lightweight and stiff.

### SUMMARY

According to some embodiments, there is provided an accessory for a vehicle wheel comprising: an outer rim configured to operatively couple with a tire; an inner rim configured to be located radially inward of the outer rim at a radial distance away from a hub of the wheel; an adaptable circumferential membrane configured to operatively couple to both the inner rim and the outer rim the adaptable circumferential membrane being structurally configured to adapt to an external force and change shape when subject to the external forces; and an attachment assembly configured to operatively couple the adaptable circumferential membrane to the outer rim and the inner rim as an overlay to wheel structural elements coupling the hub to the tire, wherein the wheel structural elements comprise at least one wheel spoke.

According to some embodiments, the adaptable circumferential membrane comprises: at least one air engaging flexible and aerodynamic surface overlaying the structural elements and coupled to the inner rim and the outer rim having a radially medial perimeter edge and a radially distal perimeter edge, wherein the radially medial perimeter edge is configured to be operatively connected to the inner rim, and the radially distal perimeter edge is configured to be operatively connected to the outer rim, forming at least one axial surface of the wheel; wherein the at least one air engaging flexible and aerodynamic surface is configured to deform under the external force and return to a neutral position when the external force is no longer present or is at least at or below a predetermined threshold.

According to some embodiments, the at least one air engaging flexible and aerodynamic surface comprises: a first air engaging flexible and aerodynamic surface configured to be operatively connected to the inner rim and the outer rim, and the radial medial edge configured to being operatively connected to the inner rim and the radially distal perimeter edge configured to be operatively connected to the outer rim, forming a first axial surface of the wheel when coupled thereto; and a second air engaging flexible and aerodynamic surface configured to be operatively connected to the inner rim and the outer rim, and the radial medial edge configured to being operatively connected to the inner rim and the radially distal perimeter edge configured to be operatively connected to the outer rim, forming a second axial surface of the wheel when coupled thereto.

According to some embodiments, the external force comprises wind.

According to some embodiments, the attachment assembly comprises at least one fastener for coupling the accessory to the wheel. According to some embodiments, the attachment assembly is configured to operatively couple the accessory to a tubular tire, a tubeless tire, or a clincher tire. According to some embodiments, the attachment assembly comprises one or more of: mechanical fastening, spline channel, snap ring, thermal bonding, adhesive, double-sided tape and co-molding. According to some embodiments, the attachment assembly is configured to operatively connect the radially distal perimeter edge of the at least one air engaging flexible and aerodynamic surface to the outer rim and to operatively connect the radially medial perimeter edge the at least one air engaging flexible and aerodynamic surface to the inner rim by one or more of: an elastic embedded in the radially distal perimeter edge of the at least one air engaging flexible and aerodynamic surface, wherein the elastic couples with ridges on each axial side of the outer rim, and/or an elastic embedded in the radially medial perimeter edge of the at least one air engaging flexible and aerodynamic surface, wherein the elastic couples with ridges on each axial side of the inner rim; an adhesive; and mechanical coupling of grooves located on the at least one air engaging flexible and aerodynamic surface with complementary grooves located on the inner rim and/or outer rim.

According to some embodiments, the adaptable circumferential membrane comprises rubber, silicone, latex, shrink wrap film, stretch film, heat shrink film, or a combination thereof.

According to some embodiments, the adaptable circumferential membrane is of variable thickness. According to some embodiments, the first air engaging flexible and aerodynamic surface and the second air engaging flexible and aerodynamic surface are of variable thickness. According to some embodiments, a thickness of the first air engaging flexible and aerodynamic surface is different than that of the second air engaging flexible and aerodynamic surface.

According to some embodiments, the at least one adaptable circumferential membrane is under tension when operatively coupled to the wheel. According to some embodiments, the adaptable circumferential membrane comprising the first air engaging flexible and aerodynamic surface is under a first tension and the second air engaging flexible and aerodynamic surface is under a second tension different than the first tension. According to some embodiments, one or more of the tension, the first tension and the second tension is in a range to yield, in a radial direction, about 0.5% to about 20% elongation, or from about 15% to about 20% elongation, or from about 1% to about 600% elongation, or from about 1% to about 89% elongation. According to some embodiments, one or more of the tension, the first tension and the second tension is about 40 psi or less, or about 0.4 ksi to about 740 ksi, or about 0.04 ksi to about 740 ksi.

According to some embodiments, the adaptable circumferential membrane comprises one or more of: a polyester film, a polyolefin film and a rubber.

According to some embodiments, wherein the first axial surface and the second axial surface are configured to provide an attached boundary layer of the airflow over the first axial surface and the second axial surface.

According to some embodiments, the radial distance is in a range of about 1% to about 99% of a total radial distance from the outer rim to the hub.

According to some embodiments, there is provided a vehicle wheel comprising the accessory according to any one of the preceding embodiments. According to some embodiments, the vehicle is a bicycle.

According to some embodiments, there is provided a kit for modifying the aerodynamic characteristics of a wheel comprising: the accessory according to any one of the preceding embodiments. According to some embodiments, the kit further comprises instructions for installing the accessory on said wheel.

### BRIEF DESCRIPTION OF THE DRAWINGS

For a better understanding of the various embodiments described herein and to show more clearly how they may be carried into effect, reference will now be made, by way of example only, to the accompanying drawings in which:

FIG. 1 depicts a wheel according to known implementations;

FIG. 2A depicts a wheel having an accessory, according to non-limiting embodiments;

FIGS. 2B and 2C depict schematics of vehicle wheels having an accessory, according to non-limiting embodiments;

FIG. 2D depicts an exploded view of an accessory and certain aspects of an attachment assembly, according to non-limiting embodiments;

FIGS. 3A to 3C depict a wheel having an accessory, according to non-limiting embodiments, under various external force conditions;

FIGS. 4A to 4C depict schematics of a wheel having an accessory, according to non-limiting embodiments, under various external force conditions;

FIGS. 4D and 4E depict schematics of a wheel having accessory, according to non-limiting embodiments;

FIG. 4F depicts an enlarged portion of a wheel having an accessory with slots in the inner rim, according to non-limiting embodiments;

FIGS. 5A to 5C depict schematics of a wheel having an accessory for mounting with different type of tires, according to non-limiting embodiments;

FIG. 6 depicts a schematic of a kit for modifying the aerodynamic characteristics of a wheel, according to non-limiting embodiments; and

FIG. 7 is a chart of wind tunnel test results of wheels with and without aerodynamic accessories, according to non-limiting embodiments.

### DETAILED DESCRIPTION

Herein described are vehicle wheels and accessories for wheels with improved aerodynamics. According to some embodiments, the cycling wheel comprises: a hub and a plurality of spokes connected thereto; an outer rim and an inner rim, the inner rim being at a radial distance away from the hub; an adaptable circumferential membrane (which comprises at least one air engaging flexible and aerodynamic surface) coupled to the inner rim and the outer rim, the adaptable circumferential membrane being structurally configured to deform under external force with the ability to return to a neutral position once the external force is no longer present or is at or below a predetermined threshold.

For example, according to some embodiments, the accessory comprises: an outer rim configured to operatively couple with a tire of the vehicle wheel; an inner rim configured to be located radially inward of the outer rim at a radial distance away from a hub of the wheel; an attachment assembly configured to operatively couple the accessory to the wheel as an overlay to structural elements coupling the hub to the tire; and an adaptable circumferential membrane configured to operatively couple to the inner rim and the outer rim, via the attachment assembly, the adaptable circumferential membrane being structurally configured to adapt to an external force and change shape when subject to the external forces.

It will be appreciated that for simplicity and clarity of illustration, where considered appropriate, reference numerals may be repeated among the figures to indicate corresponding or analogous elements. In addition, numerous specific details are set forth in order to provide a thorough understanding of the exemplary aspects of the present application described herein. However, it will be understood by those of ordinary skill in the art that the exemplary aspects described herein may be practiced without these specific details. In other instances, well-known methods, procedures and components have not been described in detail so as not to obscure the exemplary aspects described herein. Also, the description is not to be considered as limiting the scope of the exemplary aspects described herein. Any systems, method steps, method blocks, components, parts of components, and the like described herein in the singular are to be interpreted as also including a description of such systems, method steps or tasks, components, parts of components, and the like in the plural, and vice versa.

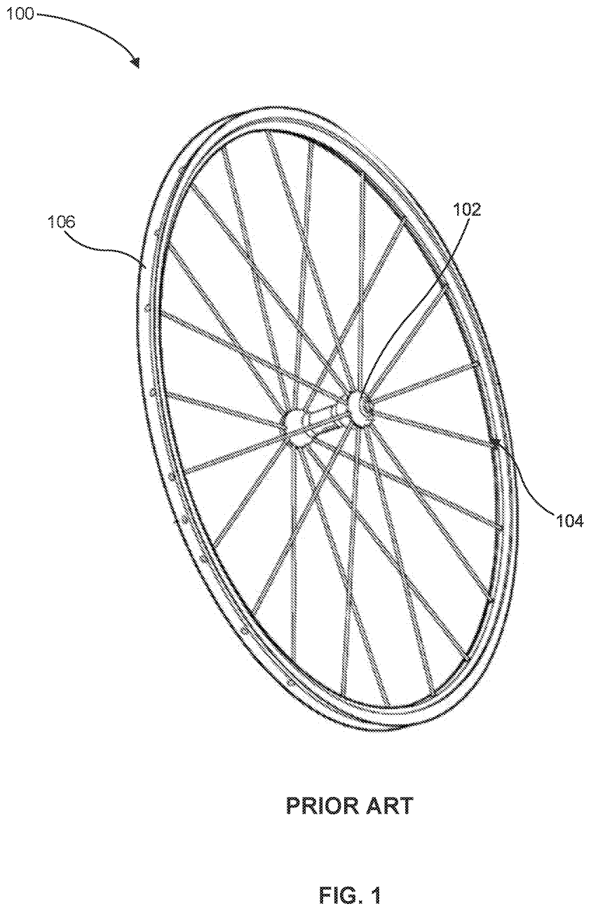

Attention is directed to FIG. 1, which depicts a side view of a conventional wheel 100. Conventional wheel 100 comprises hub 102, spokes 104 and rim 106. Conventional spoked wheels are generally stable in crosswinds and, depending on the materials used in their manufacture, can be lightweight and stiff. However, as discussed above, a major source of drag on a bicycle results from the flow of air over and around the cycling wheels and given the aerodynamic complexity of such cycling wheels, a wheel with improved aerodynamics is desirable.

Typical attempts to reduce drag have focused on the use of rigid materials and structures, with a view to providing the structural stability of conventional cycling wheels but with improved aerodynamic characteristics. Further, to decrease the drag associated with traditional spoked wheels, wheels with rims of significant depth and disc wheels have been developed, and deeper depth rims offer significantly greater aerodynamic savings but at a cost to perceived rider stability. However, the inventors have developed a vehicle wheel and vehicle wheel accessories with improved aerodynamics, that do not necessarily rely on rigid materials or structures, and without compromising rider stability.

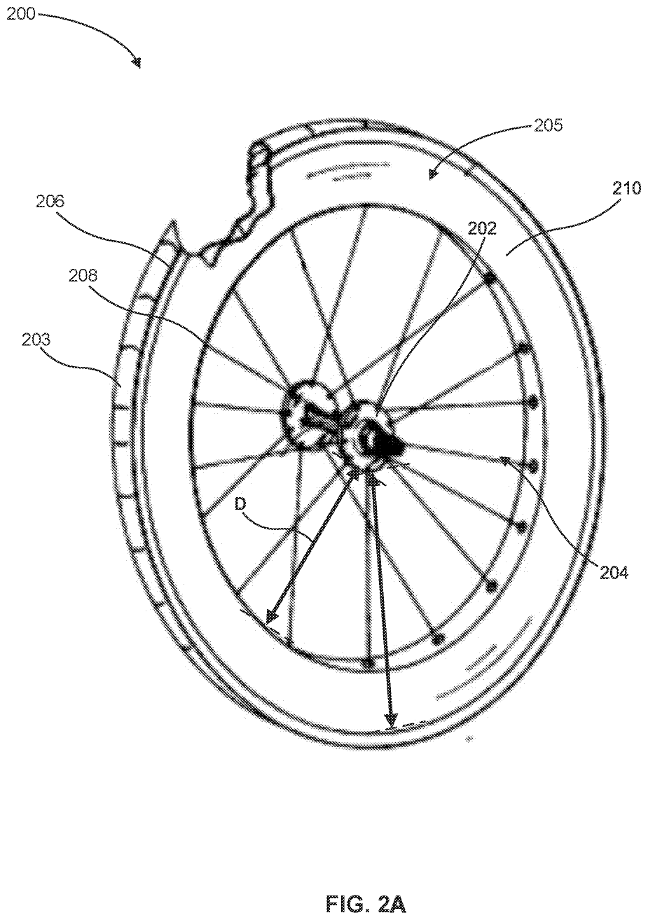

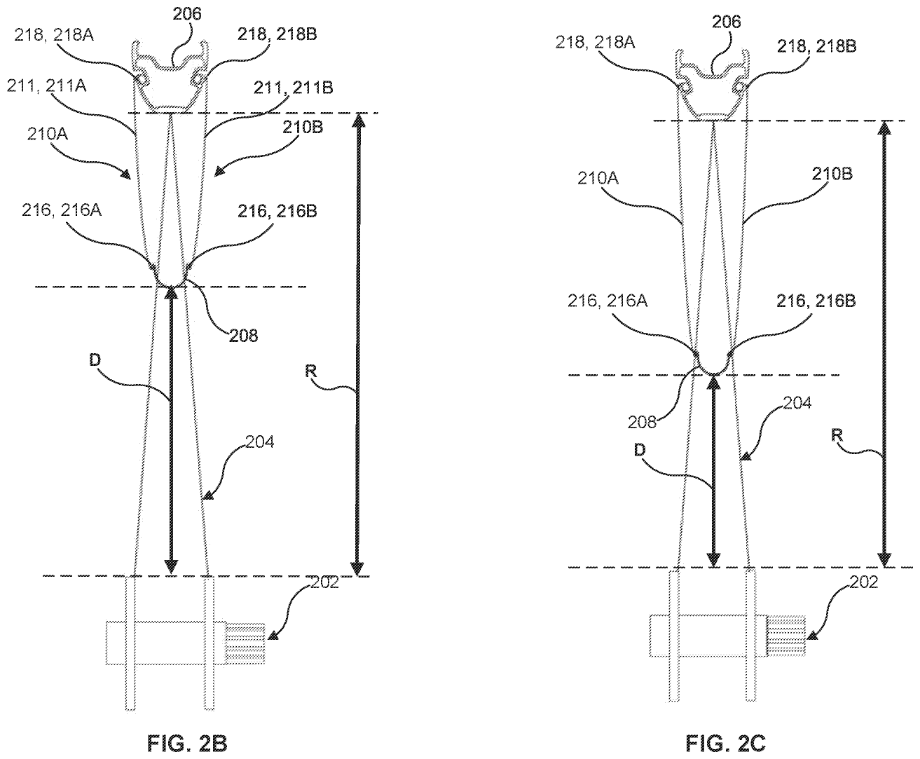

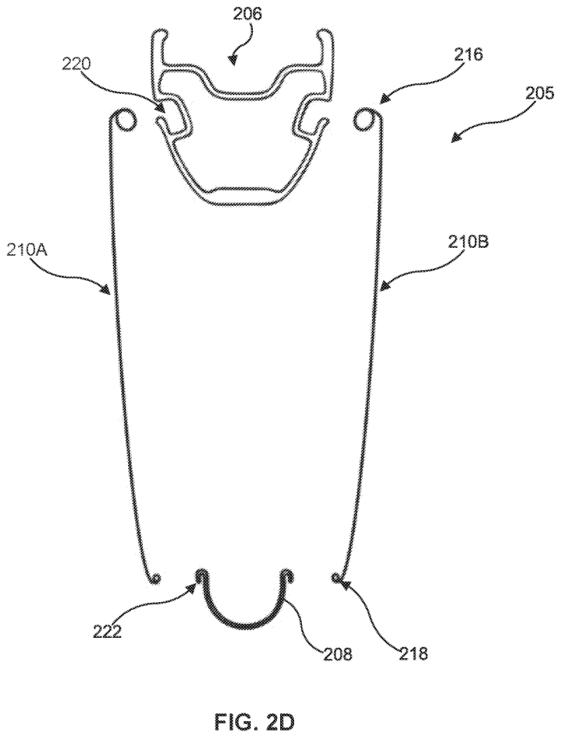

Attention is directed to FIG. 2A, which depicts a side view of cycling wheel 200 having an accessory 205, according to non-limiting embodiments. Cycling wheel 200 comprises hub 202, a plurality of spokes 204 connected thereto, an outer rim 206 and inner rim 208. Inner rim 208 is located at a radial distance, D, away from hub 202 (radially inward of the outer rim 206). The radial distance D may vary. For example, according to some embodiments, radial distance D is in a range of about 1% to about 99% of a total radial distance, R, from the outer rim to the inner rim. According to some embodiments, D is in a range of about 25 to about 30% R. According to some embodiments, D is about 40 mm or about 60 mm or about 90 mm. In traditional deep dish wheels (which are stiff), the greater the radial size of the deep dish, the better the resulting aerodynamic characteristics (due to reduced drag). However, in practice the radial distance of the deep dish usually remains much less than the maximum radius of wheel, especially if the accessory is installed on the front wheel of the bicycle (and therefore the steering column) because a full deep-dish configuration (where the dish radial length is equal to the maximum radius) would typically pose a stability/safety risk if the rider's front wheel is hit by a sudden gust of wind. In contrast, the Applicant has found that wheels having the accessories described herein usually exhibit good stability and safety in crosswinds even if D is ˜ due to, at least in part, to the ability for components of the accessories to adapt to external forces and change shape, absorbing at least some of the external forces/winds loads and reducing the aerodynamic loads experienced by the rider. As a result, wheels having the accessories described herein are not usually limited in the same way as a traditional deep dish wheel and can usually have deeper radial section without compromising on rider safety and stability.

Cycling wheel 200 further comprises accessory 205 having an adaptable circumferential membrane 210 configured to be coupled to the inner rim 208 and the outer rim 206 via at least one attachment assembly that is configured to operatively couple accessory 205 to wheel 200 as an overlay to structural elements, such as one or more of spokes 204, coupling hub 202 to tire 203. Adaptable circumferential membrane 210 is structurally configured to adapt to an external force and change shape when subjected to external forces. For example, adaptable circumferential membrane 210 may be configured to deform under an external force, such as a crosswind, with the ability to return to a neutral position once the external force is no longer present or is at or below a predetermined threshold. Adaptable circumferential membrane 210 is configured to function similarly to an airfoil that changes in camber based on the direction and magnitude of the external force. According to some embodiments, membrane 210 comprises one or more extensible materials, such as shrink-wrapped polymer, silicone, latex, stretch film, elastic/stretchable fabric and/or rubber. Any suitable material or suitable combination of materials for the adaptable circumferential membrane is contemplated.

According to some embodiments, adaptable circumferential membrane 210 comprises at least one air engaging flexible and aerodynamic surface overlaying at least some structural elements that couple the hub to the tire, such as first air engaging flexible and aerodynamic surface 210A and second sir engaging flexible and aerodynamic surface 210B (also referred to herein as aerodynamic surface 210A and aerodynamic surface 201B) (see, for example, FIGS. 2B and 2C). Aerodynamic surfaces 210A, 210B are configured to deform and/or change shape when wheel 200, and therefore also the aerodynamic surfaces 201A, 201B, is subjected to an external force, E (which may be an external wind force). Such deformation and change in shape is demonstrative of, at least in part, the aerodynamic surfaces' ability to adapt to an external force. Through this adaptation, the aerodynamic surfaces 210A and 210B usually creates a resulting high side of the airfoil, which generates lift and resulting thrust.

According to some embodiments, one or more of aerodynamic surfaces 210 are installed under tension (“tension” being defined herein as a pulling force/tensile load on a material). For example, according to some embodiments, each of aerodynamic surfaces 210A, 210B are under the same first or initial tensile load. According to some embodiments, aerodynamic surface 210A is under a different tensile load to aerodynamic surface 210B. According to some embodiments, the first or initial tensile load is in a range to yield about 1% to about 80% elongation, 0.5% to about 20% elongation, or from about 15% to about 20% elongation of the respective aerodynamic surface in a radial direction. According to some embodiments, the first or initial tensile load is about 40 psi or less. According to some embodiments, the first or initial tensile load is in a range of about 0.4 ksi to about 740 ksi. In placing the aerodynamic surfaces 210A, 210B under an initial tension, the thickness of the material and its inherent stiffness is usually taken into account. The Applicant has found that if the combined material stiffness and pre-tension is too low, then the dynamic shape of the surface may bulge out, resulting in reduced aerodynamics. At the other extreme, if the combined material stiffness and pre-tension is too high then the aerodynamic surfaces 210A, 210B of the adaptable circumferential membrane are usually unable to morph and change shape in a manner to improve or obtain the desired improvement in aerodynamics with the result being reduced or no performance gain over a traditional rigid wheel.

Any suitable materials or combination of materials for the adaptable circumferential membrane and the aerodynamic surfaces are contemplated. For example, according to some embodiments, the adaptable circumferential membrane and the aerodynamic surfaces comprise one or more of: a polyester film, a polyolefin film and a rubber. According to some embodiments, the polyester film and/or the polyolefin film is of a thickness of about 0.025 mm to about 1.50 mm, and the first or initial tensile load is in a range to yield about 1% to about 89% elongation in a radial direction. According to some embodiments, the rubber is of a thickness of about 0.15 mm to about 0.25 mm, and the first or initial tensile load is in a range to yield about 1% to about 600% elongation in a radial direction.

As noted above, according to some embodiments, the aerodynamic surfaces are under different tensile loads or under the same tensile loads. The inclusion of symmetrical or asymmetrical tensile loads may depend on whether the accessory is being installed on the front wheel or the rear wheel of the bicycle. For example, the spoke angles are usually symmetrical on the drive side and non-drive side of the wheel, whereas the spoke angles of a rear wheel on the drive side and non-drive side are usually different because the gear cluster is on the drive side. According to some embodiments, the tension of each aerodynamic surface can be individually adjusted and/or selected to allow the inner rim to maintain a neutral/centered position directly below/in-line with the outer rim.

Each of the aerodynamic surfaces 210A, 210B has a radially medial perimeter edge and a radially distal perimeter edge, such as radially medial perimeter edges 216 (also referred to as radially medial perimeter edge 216A in respect of aerodynamic surface 210A and as radially medial perimeter edge 216B in respect of aerodynamic surface 210B) and radially distal perimeter edges 218 (also referred to as radially distal perimeter edge 218A in respect of aerodynamic surface 210A and as radially distal perimeter edge 218B in respect of aerodynamic surface 210B). The radially medial perimeter edges are each configured to be operatively connected to the inner rim, such as inner rim 208, and the radially distal perimeter edges are each configured to be operatively connected to the outer rim, such as outer rim 206. Each of aerodynamics surfaces 210A, 210B forms an axial surface of the wheel when coupled thereto (see, for example, first axial surface 211A and second axial surface 211B, collectively referred to herein as axial surfaces 211). According to some embodiments, the axial surfaces 211 are configured to yield an attached boundary layer. According to some embodiments, axial surfaces 211 are enabled to morph/change shape and move with the airflow over the wheel, which helps the boundary layer to remain attached to the axial surface rather than separate and become turbulent (which would result in additional drag forces). The longer the boundary layer of the airflow is able to stay attached to the axial surfaces (over a greater length of the surface in the direction of airflow), usually the better the resulting aerodynamic characteristics of the wheel.

As discussed above, the accessory described herein comprises an attachment assembly configured to operatively couple the adaptable circumferential membrane to the outer rim and the inner rim as an overlay to wheel structural elements coupling the hub to the tire. Any suitable manner of operatively coupling the adaptable circumferential membrane to the outer rim and the inner rim is contemplated. According to some embodiments, the attachment assembly comprises at least one fastener. According to some embodiments, the attachment assembly comprises one or more of: a mechanical fastener, a thermal bond, an adhesive, spline channel, snap ring, thermal bonding, adhesive, double-sided tape, co-molding and an elastic embedded in the radially distal perimeter edge of the at least one air engaging flexible and aerodynamic surface and/or an elastic embedded in the radially medial perimeter edge of the at least one air engaging flexible and aerodynamic surface, wherein the elastic couples with ridges on each axial side of the rim (the radially distal perimeter edge to the outer rim and the radially medial perimeter edge to the inner rim), and a mechanical coupling of grooves located on the at least one air engaging flexible and aerodynamic surface with complementary grooves located on the inner rim and/or outer rim. For example, the attachment assembly comprises snap fit components, such as distal snap fit prong(s) 216 and medial snap fit prong(s) 218 of aerodynamic surfaces 210A, 210B configured to fittingly engage complementary shaped attachment points of the outer rim and the inner rim, such as wheel attachment grooves/recesses 220 and 222 (see FIG. 2D).

A typical attachment scheme of a rim to a tire is shown in U.S. Pat. No. 8,708,424 B2 (Mercat et al.) in which a groove is used to locate the fairing between the tire and the rim. In contrast, although the attachment assembly described herein may, according to some embodiments, include a groove to hold edges of the at least one air engaging flexible and aerodynamic surface, the gap between the tire and the respective rim is not covered (the coupling is between the perimeter edge and the rim). The “snap fit” prong or ring may or may not be elastic.

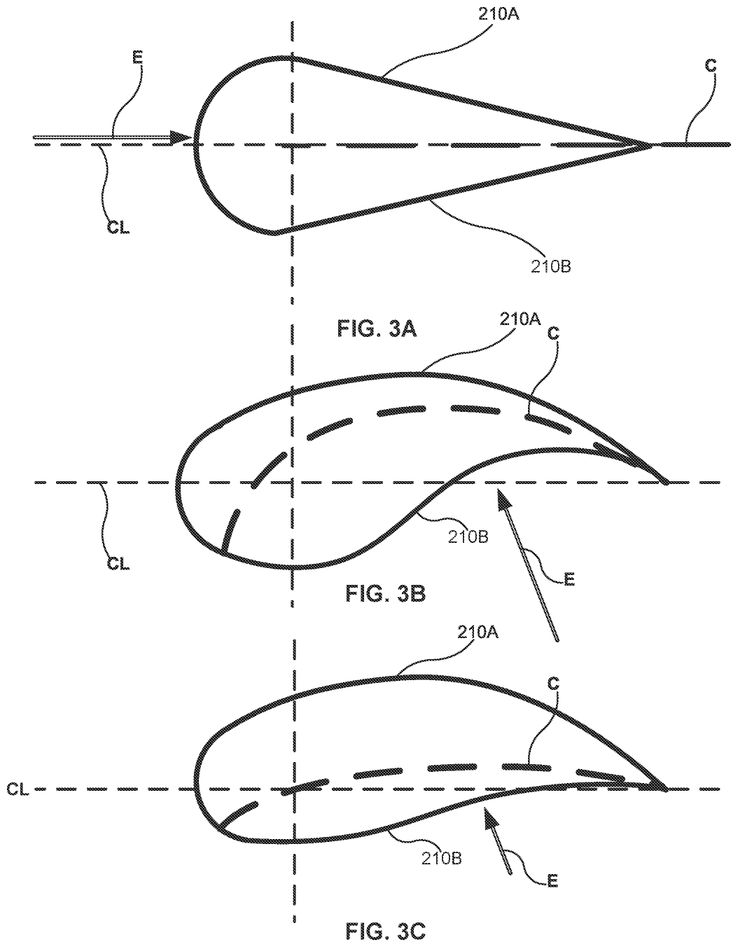

Attention is directed to FIGS. 3A to 3C. FIGS. 3A to 3B depict schematics of cycling wheel 200 (top view) as an airfoil under external force E. In FIG. 3A, cycling wheel 200 external force E is zero or at/below a threshold. Membrane 210 is in a neutral position, with a neutral camber C. In FIG. 3B, cycling wheel 200 is under an external force E that is greater than the threshold. In response, the membrane 210 adapts and deforms such that the camber C increases. In FIG. 3C, the external force E decreases (e.g., in magnitude), but is still above the threshold, and camber C decreases accordingly.

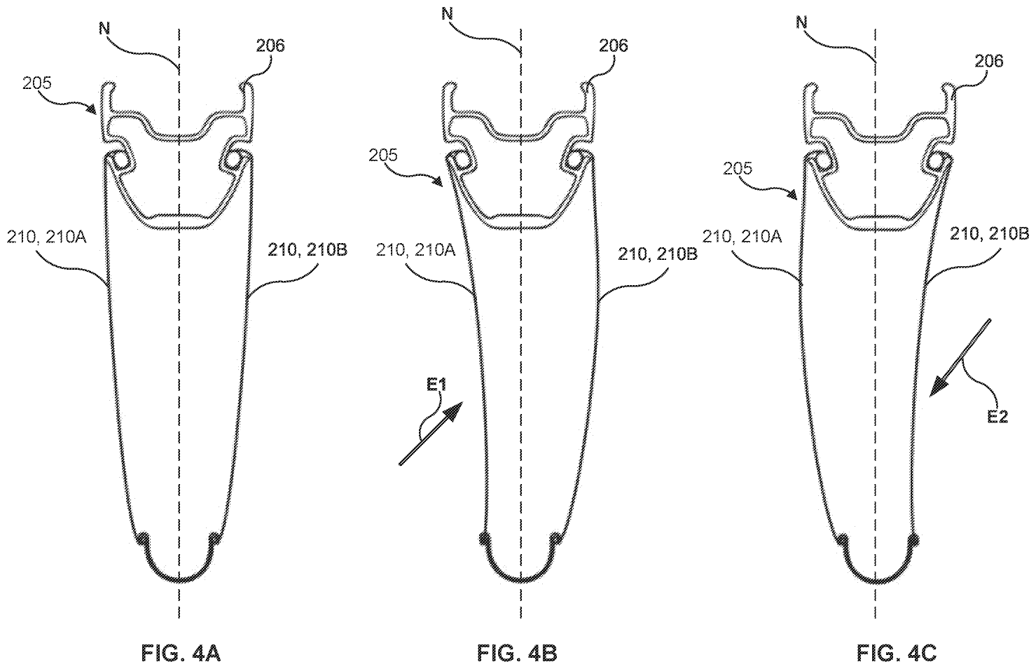

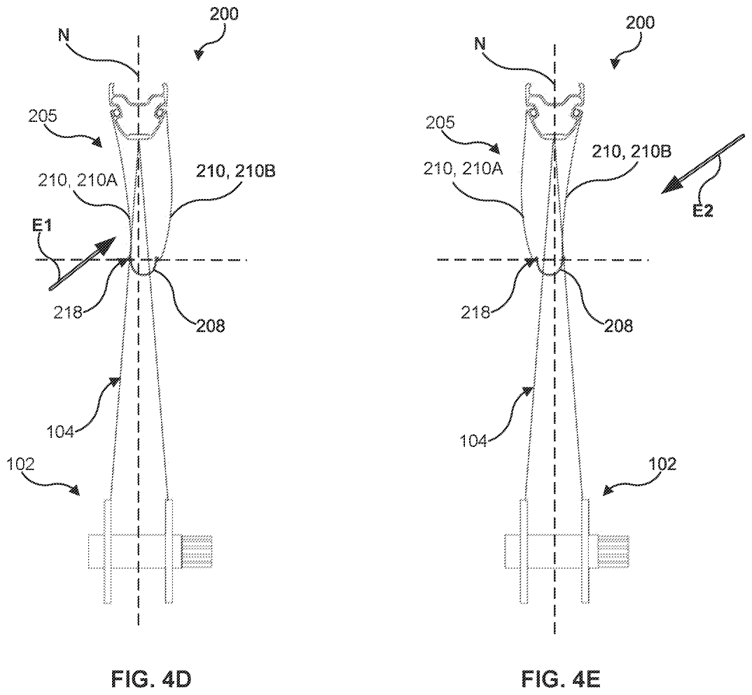

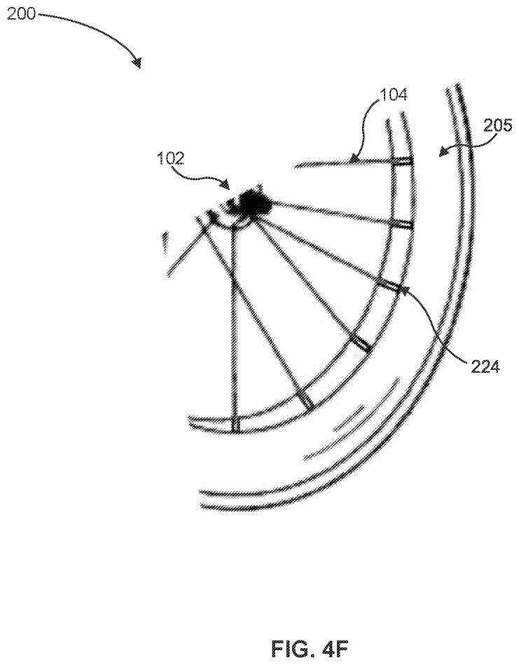

Attention is directed to FIGS. 4A to 4C, which depict schematics of cycling wheel 200 cycling wheel 200 (top view) with membrane 210 in which adaptable circumferential membrane 210 is shown in deformed and undeformed positions. According to the embodiment depicted in FIGS. 4A to 4C, radially medial perimeter edges 216 are fixed in position relative to the neutral axis N. In FIG. 4A, adaptable circumferential membrane 210 is undeformed. In response to external force in a first direction, E1, aerodynamic engaging surface 210A deforms, curving inwards towards the neutral axis N (FIG. 4B). In response to an external force in a second direction opposite the first direction, E2, aerodynamic 210B deforms, curving inwards towards the neutral axis (FIG. 4C).

According to some embodiments, inner rim 208 and adaptable circumferential membrane 210 are configured to allow for lateral movement of radially medial perimeter edges 218 relative to the neutral axis N when subject to an external force. According to some embodiments, inner rim 208 may comprise a plurality of lateral slots, such as slot(s) 224 (see FIG. 4F), in which radially medial perimeter edges 218 are enabled to laterally slide as the aerodynamic surfaces 210 adapt and change shape in response to an external force. For example, as shown in FIGS. 4D and 4E, when subjected to an external force in a first direction, E1, both aerodynamic surfaces 210 are enabled to deform, aerodynamic surface 210A towards the neutral axis N and aerodynamic surface 210B away from the neutral axis, since radially medial perimeter edges are not in a fixed lateral position (which also travel laterally in the first direction with the aerodynamic surfaces 210 since they are not constrained from lateral movement). Similarly, when subjected to an external force in a second direction, E2, both aerodynamic surfaces 210 are enabled to deform, aerodynamic surface 210A away from the neutral axis N and aerodynamic surface 210B towards the neutral axis, since radially medial perimeter edges are not in a fixed lateral position.

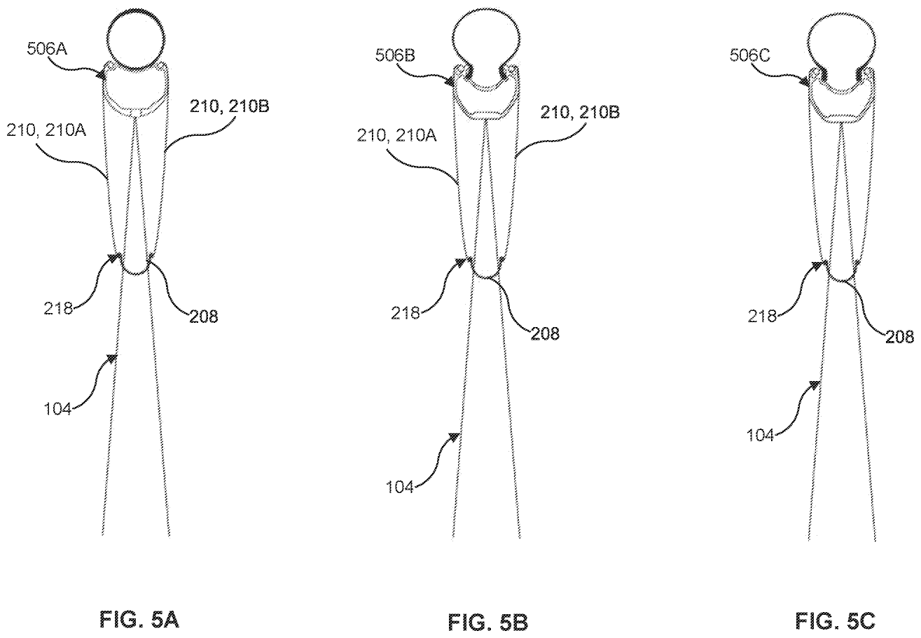

The described adaptable membrane may be used with a variety of inner and/or outer rims and a variety of rim attachments. Attention is directed to FIGS. 5A to 5C, which depict cross-sectional views of example cycling wheels having an adaptable membrane as described herein, such as a conventional tubular outer rim 506A (FIG. 5A), outer clincher rim 506B (FIG. 5B) or a hookless outer rim 506C (FIG. 5C). A variety of mounts are contemplated, and the preceding list is not to be considered limiting.

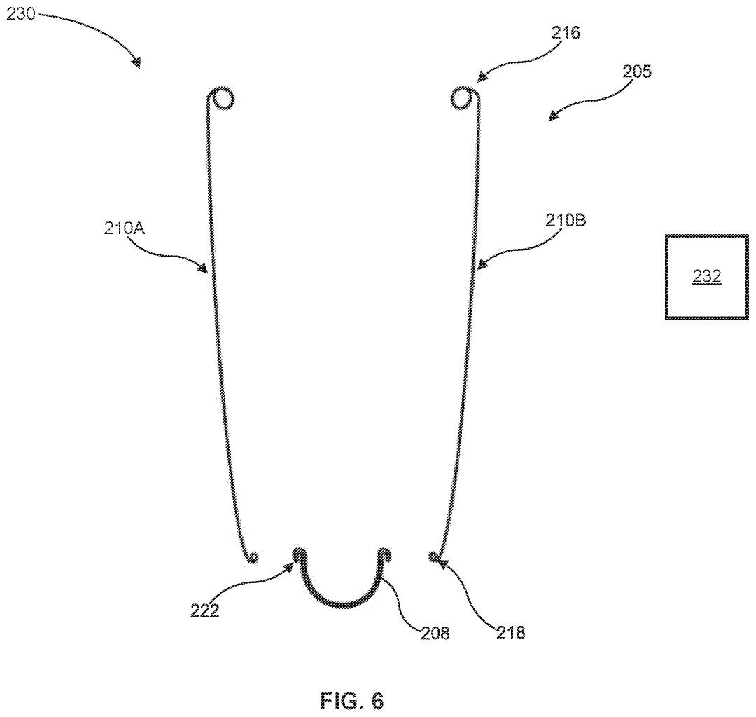

According to some embodiments, there is provided a kit comprising the accessory for a vehicle wheel, such as accessory 205. For example, according to some embodiments, there is provided kit 230 comprising accessory 205 (FIG. 6). According to some embodiments, kit 230 further comprises instructions 232 for installing accessory 205 on a vehicle wheel, such as wheel 100.

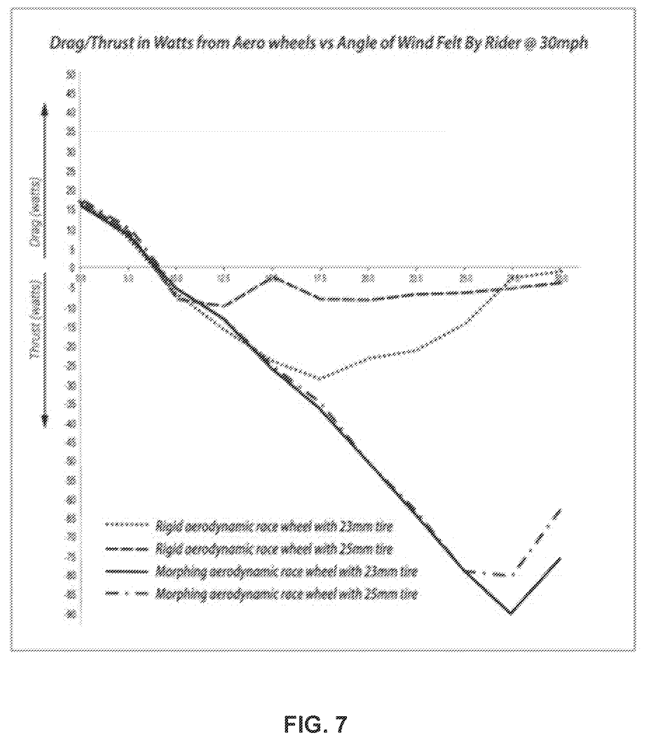

Attention is directed to FIG. 7, which depicts the wind tunnel test results of wheels having adaptable/morphable accessories as according to some embodiments of the application compared to conventional aerodynamic wheels. The stall point for each wheel in the graph is indicated by the point of upwards inflection (where the airflow separates from the wheel surface and instability forces begin to be felt by the rider). It can be seen that wheels having the adaptable/morphable accessory do not necessarily stall until a yaw angle (Y-axis) much higher than conventional rigid wheels and that they may generate up to three times the thrust or negative drag compared to conventional aerodynamic wheels.

Persons skilled in the art will appreciate that there are yet more alternative implementations and modifications possible, and that the above examples are only illustrations of one or more implementations.

### Interpretation

It will also be understood that for the purposes of this application, “at least one of X, Y, and Z” or “one or more of X, Y, and Z” language can be construed as X only, Y only, Z only, or any combination of two or more items X, Y, and Z (e.g., XYZ, XYY, YZ, ZZ).

In the present application, components may be described as being “configured to” or “enabled to” perform one or more functions. Generally, it is understood that a component that is configured to or enabled to perform a function is configured to or enabled to perform the function, or is suitable for performing the function, or is adapted to perform the function, or is operable to perform the function, or is otherwise capable of performing the function.

Additionally, components in the present application may be described as being “operatively connected to”, “operatively coupled to”, and the like, to other components. It is understood that such components are connected or coupled to each other in a manner to perform a certain function. It is also understood that “connections”, “coupling” and the like, as recited in the present application include direct and indirect connections between components.

References in the application to “one embodiment”, “an embodiment”, “an implementation”, “a variant”, etc., indicate that the embodiment, implementation or variant described may include a particular aspect, feature, structure, or characteristic, but not every embodiment, implementation or variant necessarily includes that aspect, feature, structure, or characteristic. Moreover, such phrases may, but do not necessarily, refer to the same embodiment referred to in other portions of the specification. Further, when a particular aspect, feature, structure, or characteristic is described in connection with an embodiment, it is within the knowledge of one skilled in the art to affect or connect such module, aspect, feature, structure, or characteristic with other embodiments, whether or not explicitly described. In other words, any module, element or feature may be combined with any other element or feature in different embodiments, unless there is an obvious or inherent incompatibility, or it is specifically excluded.

It is further noted that the claims may be drafted to exclude any optional element. As such, this statement is intended to serve as antecedent basis for the use of exclusive terminology, such as “solely”, “only”, and the like, in connection with the recitation of claim elements or use of a “negative” limitation. The terms “preferably”, “preferred”, “prefer”, “optionally”, “may”, and similar terms are used to indicate that an item, condition or step being referred to is an optional (not required) feature of the invention.

The singular forms “a”, “an”, and “the” include the plural reference unless the context clearly dictates otherwise. The term “and/or” means any one of the items, any combination of the items, or all of the items with which this term is associated. The phrase “one or more” is readily understood by one of skill in the art, particularly when read in context of its usage.

The term “about” can refer to a variation of +5%, +10%, +20%, or +25% of the value specified. For example, “about 50” percent can in some embodiments carry a variation from 45 to 55 percent. For integer ranges, the term “about” can include one or two integers greater than and/or less than a recited integer at each end of the range. Unless indicated otherwise herein, the term “about” is intended to include values and ranges proximate to the recited range that are equivalent in terms of the functionality of the composition, or the embodiment.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. A recited range includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc.

As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio.

1. An accessory for a vehicle wheel comprising:
an outer rim configured to operatively couple with a tire;
an inner rim configured to be located radially inward of the outer rim at a radial distance away from a hub of the wheel;
an adaptable circumferential membrane configured to operatively couple to both the inner rim and the outer rim the adaptable circumferential membrane being structurally configured to adapt to an external force and change shape when subject to the external forces; and
an attachment assembly configured to operatively couple the adaptable circumferential membrane to the outer rim and the inner rim as an overlay to wheel structural elements coupling the hub to the tire;
wherein the wheel structural elements comprise at least one wheel spoke.

2. The accessory of claim 1, wherein the adaptable circumferential membrane comprises:
at least one air engaging flexible and aerodynamic surface overlaying the structural elements and coupled to the inner rim and the outer rim having a radially medial perimeter edge and a radially distal perimeter edge, wherein the radially medial perimeter edge is configured to be operatively connected proximate to the inner rim, and the radially distal perimeter edge is configured to be operatively connected proximate to the outer rim, forming at least one axial surface of the wheel;
wherein the at least one air engaging flexible and aerodynamic surface is configured to deform under the external force and return to a neutral position when the external force is no longer present or is at least at or below a predetermined threshold.

3. The accessory of claim 2, wherein the at least one air engaging flexible and aerodynamic surface comprises:
a first air engaging flexible and aerodynamic surface configured to be operatively connected to the inner rim and the outer rim, and the radial medial edge configured to being operatively connected to the inner rim and the radially distal perimeter edge configured to be operatively connected to the outer rim, forming a first axial surface of the wheel when coupled thereto; and
a second air engaging flexible and aerodynamic surface configured to be operatively connected to the inner rim and the outer rim, and the radial medial edge configured to being operatively connected to the inner rim and the radially distal perimeter edge configured to be operatively connected to the outer rim, forming a second axial surface of the wheel when coupled thereto.

4. The accessory of claim 1, wherein the external force comprises wind.

5. The accessory of claim 1, wherein the attachment assembly comprises:
at least one fastener.

6. The accessory of claim 1, wherein the attachment assembly is configured to operatively couple the accessory to a tubular tire, a tubeless tire, or a clincher tire.

7. The accessory of claim 1, wherein the adaptable circumferential membrane comprises rubber, silicone, latex, shrink wrap film, stretch film, heat shrink film, or a combination thereof.

8. The accessory of claim 1, wherein the adaptable circumferential membrane is of variable thickness.

9. The accessory of claim 3, wherein the first air engaging flexible and aerodynamic surface and the second air engaging flexible and aerodynamic surface are of variable thickness.

10. The accessory of claim 3, wherein a thickness of the first air engaging flexible and aerodynamic surface is different than that of the second air engaging flexible and aerodynamic surface.

11. The accessory of claim 1, wherein the at least one adaptable circumferential membrane is under tension when operatively coupled to the wheel.

12. The accessory of claim 11, wherein the adaptable circumferential membrane comprising the first air engaging flexible and aerodynamic surface is under a first tension and the second air engaging flexible and aerodynamic surface is under a second tension different than the first tension.

13. The accessory of claim 12, wherein one or more of the first tension and the second tension is in a range to yield, in a radial direction, about 0.5% to about 20% elongation, or from about 15% to about 20% elongation, or from about 1% to about 600% elongation, or from about 1% to about 89% elongation.

14. The accessory of claim 11, wherein one or more of the tension, the first tension and the second tension is about 40 psi or less, or about 0.4 ksi to about 740 ksi, or about 0.04 ksi to about 740 ksi.

15. The accessory of claim 11, the adaptable circumferential membrane comprises one or more of: a polyester film, a polyolefin film and a rubber.

16. The accessory of claim 3, wherein the first axial surface and the second axial surface are configured to provide an attached boundary layer of the airflow over the first axial surface and the second axial surface.

17. The accessory of claim 5, wherein the attachment assembly comprises one or more of: mechanical fastening, spline channel, snap ring, thermal bonding, adhesive, double-sided tape, co-molding.

18. The accessory of claim 3, wherein the attachment assembly is configured to operatively connect the radially distal perimeter edge of the at least one air engaging flexible and aerodynamic surface to the outer rim and to operatively connect the radially medial perimeter edge the at least one air engaging flexible and aerodynamic surface to the inner rim by one or more of:
an elastic embedded in the radially distal perimeter edge of the at least one air engaging flexible and aerodynamic surface, wherein the elastic couples with ridges on each axial side of the outer rim, and/or an elastic embedded in the radially medial perimeter edge of the at least one air engaging flexible and aerodynamic surface, wherein the elastic couples with ridges on each axial side of the inner rim;
adhesive; and
mechanical coupling of grooves located on the at least one air engaging flexible and aerodynamic surface with complementary grooves located on the inner rim and/or outer rim.

19. The accessory of claim 1, wherein the radial distance is in a range of about 1% to about 99% of a total radial distance from the outer rim to the hub.

20. A vehicle wheel comprising:
the accessory of claim 1.

21. The vehicle wheel of claim 20, wherein the vehicle is a bicycle.

22. A kit for modifying the aerodynamic characteristics of a wheel comprising:
the accessory of claim 1.

23. The kit of claim 22 further comprising instructions for installing the accessory on said wheel.
